(19) United States
(12) Patent Application Publication
(10) Pub. No.: US 2006/0019605 A1
(43) Pub. Date: Jan. 26, 2006

(54) Wireless signal transfer by sound waves

(76) Inventor: Jeng-Jye Shau, Palo Alto, CA (US)

Correspondence Address: JENG-JYE SHAU, 991 AMARILLO AVE., PALO ALTO, CA, 94303, US

(21) Appl. No.: 10/896,354

(22) Filed: Jul. 20, 2004

(51) Int. Cl. H04B 7/00

(52) U.S. Cl. 455/66.1

(57) ABSTRACT

The present invention uses mechanical sound waves as sound waves as signal carriers for establishing wireless connections for wide varieties of devices. Example applications include computer mice, computer keyboard, video game controller, wireless telephone, cellular phone, household appliance control, ID device, and security system.

### BACKGROUND OF THE INVENTION

The present invention relates to wireless signal transfer methods and devices, and more particularly to wireless devices using mechanical sound waves as signal transfer carrier.

In the past decade, wireless communication technologies progressed in an explosive rate. Wireless telephones have become the most common personal communication devices. Wireless Internet and wireless networks allow flexible information exchanges. These wireless technologies have caused major impacts to human life. The resulting commercial successes provided tremendous amounts of resources devoted to refine all the related technologies such as signal processing methods, data transfer protocols, radio frequency (RF) integrated circuit (IC), communication software, error correction, noise filtering, and so on. It is therefore a natural trend to extend these highly successful, well-developed technologies to more applications. For example, the “blue tooth” standard is developed with an intention to replace many wired electrical devices with wireless devices. However, the wireless revolution is not making fast progress in supposedly simple applications such as the computer mouse or household appliances. The major purpose of the present invention is to provide practical wireless solutions in those areas, and to provide an alternative media for wireless applications.

To facilitate better understanding of the present invention, we should discuss the reasons existing wireless technologies developed for cellular phone and networking are not the best choice for many applications. Most of existing wireless communication methods use modulated radio frequency (RF) electromagnetic (EM) waves as signal transfer carrier. EM waves provide many advantages over other types of communication carrier. It can carry signals through many barriers to reach large areas at light speed. The carrier frequencies for RF wireless signals are typically around 10⁹ cycles per second (GHZ). The size of antenna for GHZ EM signals is proper for wireless applications. The antenna needed for lower frequency EM waves is too big. Such GHZ signal also provides wide bandwidth to achieve fast data transfer rate. RF wireless systems are therefore proven to be highly successful for applications such as cellular phones, wireless Internet, or wireless local area networks. However, these advantages of RF signals are not applicable to all cases. Many devices (e.g. computer mouse, key board, video game controller, motion sensors), especially human interface devices, only need to handle a few events per second, and the signals only need to travel a few feet instead of a few miles. The advantages of RF signals became liabilities for those applications. RF signals are carried by GHZ EM waves. The integrated circuits (IC) needed to support RF circuits are more difficult to build than most of IC because RF circuits are very sensitive to small variations in parasitic impedances. RF IC is therefore more expensive and more difficult to build than common IC. RF circuits also consume a lot of power, limiting the operation time of battery powered portable devices. It is therefore desirable to provide other types of wireless data transfer methods that are more suitable for short distance, low data rate operations. The solution proposed by the present invention is to use sound, instead of RF EM waves, as the signal transfer carrier for those applications.

Sound is probably the most ancient wireless communication carrier. We are born to communicate with our voices. Many researchers have studied voice recognition technologies to allow direct communication with machines using human voice. Voice recognition methods analyze human voice and try to determine its meaning to control machines accordingly. However, human voice, although easily distinguishable by the human brain, is actually extremely complex for scientific analysis. Simple words like “yes” or “no” comprise very complex sound waveforms, and the spectrum is different when different people pronounce the same word. Even when the same person speaks the same word, the voice waveforms still can be dramatically different dependent on the mood and conditions. The voice recognition procedures are therefore extremely complex and expensive, requiring a lot of computation power and the results are often less than perfect.

If we use sound waves in a different way, “yes” or “no” can be treated as binary “1” or “0” carried by very simple sound wave with high efficiency. The present invention does not use sound waves as human languages. Instead, sound waves are treated as signal carrier in ways similar to the ways we use EM waves to carry data. Signals are modulated into and demodulated from sound waves. Most signal processing methods developed for EM waves are therefore applicable for sound waves. The frequency for human voice is less than 8 thousand cycles per second (KHZ). Ultrasound waves can have higher frequency such as a few million cycles per second (MHZ). Signal at such frequencies are very easy to analyze using existing signal processing methods. Typical IC are more than enough to execute necessary operations, we no longer need expensive RF IC. It is therefore far more cost efficient to use sound waves as signal carriers for most human interface devices. Sound waves also can be easily generated and detected. We often can avoid using batteries for devices of the present invention. Scientists have been able to generate very high frequency ultrasound waves up to GHZ. It is therefore possible to use sound signals for high data rate operations. Sound can go through many types of barriers and travel through a useful distance. It is therefore highly desirable to use sound waves as communication carrier for many practical applications.

Sound waves, especially ultrasound waves, have been used in applications such as cleaning, cutting, imagining, flow measurement, distance measurement, location tracking (Sonar), fault examination, medical examination, . . . , and so on. IEEE Ultrasonic Symposium collected excellent publications for those applications. Andrews disclosed an ultrasound mouse device in U.S. Pat. No. 6,624,808 that used ultrasound pulses as location tracking vehicle in similar principles as Sonar. Although Andrews' invention is a wireless mouse, it did not use sound waves as signal transfer carriers. Varela, et al. disclosed signal-processing apparatus for ultrasonic thermometers in U.S. Pat. No. 4,772,131. Ultrasound waves were used to measure temperature, not as signal transfer carriers. Tino disclosed a security system used ultrasonic transducer for distance measurement in U.S. Pat. No. 5,280,622. Tino used sound waves for measurement, not for signal transfer. Cady disclosed methods to build ultrasonic transducers and sensors on a single integrated circuit chip in U.S. Pat. No. 4,432,007 and U.S. Pat. No. 4,262,399. These inventions have not disclosed a method or apparatus to make use of the sound waves for wireless signal transmissions as will be further discussed below in this invention.

### SUMMARY OF THE INVENTION

The primary objective of this invention is, therefore, to reduce the cost and power of wireless devices by using sound waves as signal carriers. The other objective of this invention is to provide portable interface devices that do not need to use batteries. Another major objective is to provide an alternative carrier for wireless devices. These and other objects are accomplished by utilization of sound waves as signal carriers.

While the novel features of the invention are set forth with particularly in the appended claims, the invention, both as to organization and content, will be better understood and appreciated, along with other objects and features thereof, from the following detailed description taken in conjunction with the drawing.

### BRIEF DESCRIPTION OF THE DRAWINGS

FIGS. 1(a-c) compare computer input/output (I/O) interface of the present invention with prior art computer interfaces;

FIG. 1(d) shows examples of mechanical sound signals;

FIGS. 2(a-d) are symbolic block diagrams comparing wireless signal transfer methods of the present invention with prior art methods;

FIGS. 3(a-i) compare the structures between computer mice of the present invention with the structure of prior art computer mice;

FIG. 4 shows a noise reduction method of the present invention;

FIGS. 5(a-d) illustrate application examples of the present invention on wireless game controllers;

FIGS. 6(a-g) illustrate application examples of the present invention on wireless voice interface devices;

FIGS. 7(a-d) illustrate applications of the present invention on household appliances;

FIGS. 8(a-f) illustrate applications of the present invention on security systems; and

FIG. 9 illustrates an audio hot water control device of the present invention.

### DETAILED DESCRIPTION OF THE INVENTION

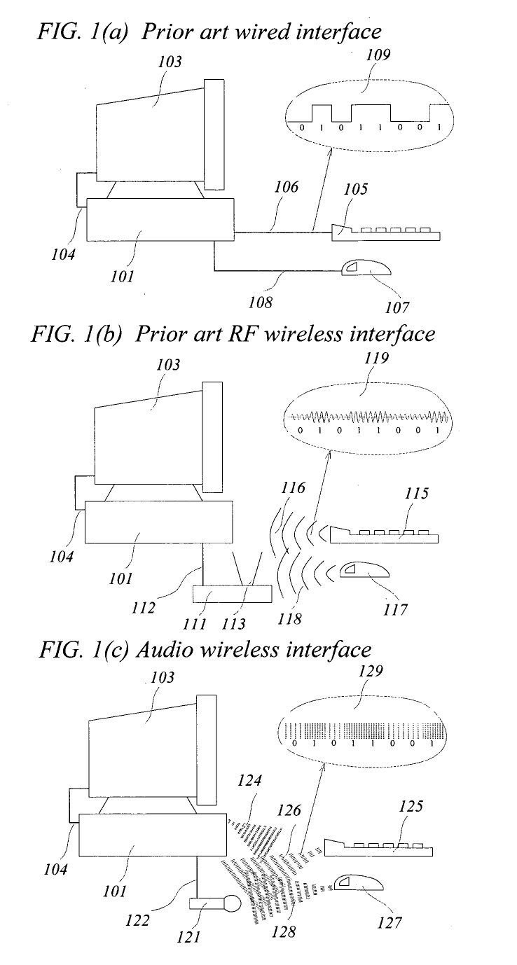

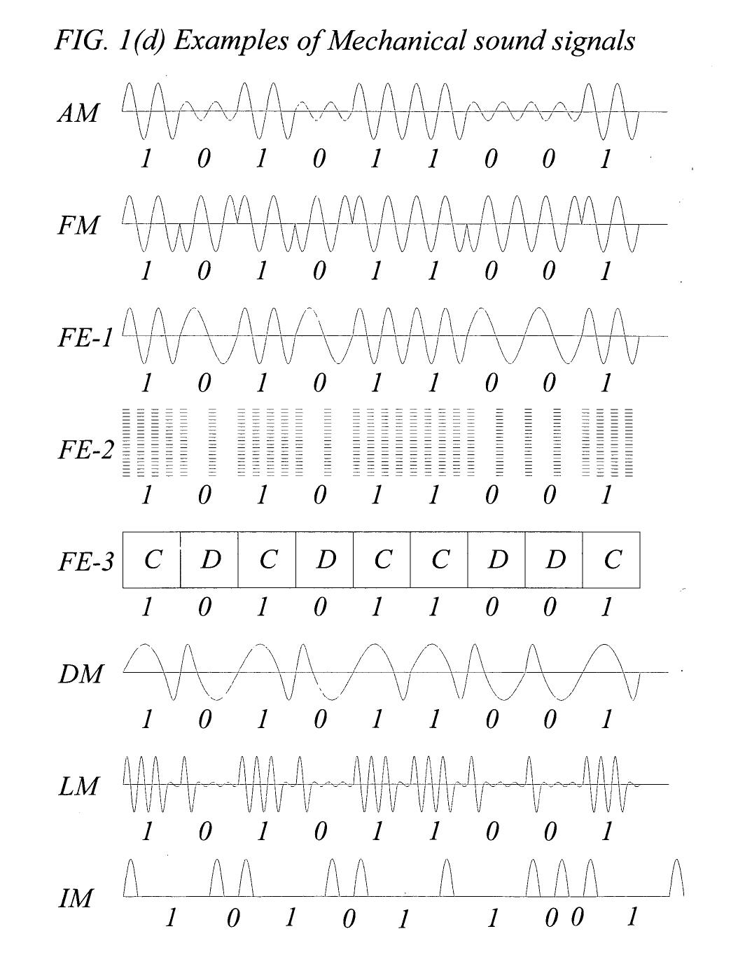

In order to facilitate better understanding of the present invention, FIGS. 1(a-c) use simplified computer systems as examples to compare the differences between prior art methods and the methods of the present invention. FIG. 1(a) shows a conventional personal computer (101) equipped with a monitor (103), a keyboard (105), and a mouse (107) as its input/output (I/O) devices. These I/O devices (103, 105, 107) are typically connected to the computer (101) through electrical wires (104, 106, 108) as illustrated in FIG. 1(a). There are wide varieties of protocols to support these wired connections. A current art mouse (107) typically uses Universal Serial Bus (USB) to communicate with the computer (101). The keyboard (105) typically uses a 6-wire bus connection. These wired connections (104, 106, 108) provide power and transfer digital signals (109) to the I/O devices. FIG. 1(a) shows a simplified example of a digital data string (109) where binary data ‘1’ is represented by high voltages while binary data ‘0’ is represented by low voltages. The actual data transfer protocols can be very complex. These methods are well known to those familiar to the art so that we only show simplified examples for clearer understanding. Such wired connections can achieve high data rate at high signal quality, but they often cause inconveniences and spatial limitations. Wireless devices are designed to make I/O devices more convenient for the users. FIG. 1(b) shows an example of a prior art personal computer equipped with a wireless key board (115) and a wireless mouse (117). The structures and fundamental functions of the wireless key board (115) and the wireless mouse (117) are identical to the conventional devices (105, 107) in FIG. 1 except that these wireless devices communicate with the computer (101) through radio frequency (RF) electro-magnetic (EM) waves (116, 118). The computer (101) needs to have an RF transceiver/receiver (111) with RF antenna (113) that can transmit or receive RF signals. FIG. 1(b) shows an example of amplitude modulated (AM) RF signal string (119) where binary data ‘1’ is represented by larger amplitude while binary data ‘0’ is represented by smaller amplitude. The actual data transfer protocols can be very complex. The signals can be frequency encoded (FE), phase modulated (PM), . . . , and so on. Signal processing for such RF wireless devices are by far more complex than for wired connections because we need to handle the effects of noise, inference, echo, distortion, . . . , and so on. The carrier frequencies for RF wireless signals are typically around 10⁹ cycles per second (GHZ). Due to its high frequency, special integrated circuits (called RF IC) are needed to support transmission and receiving of the RF signals. The overall complexity of RF wireless system is therefore highly sophisticated and expensive. These methods are well known to those familiar to the art so that only simplified examples are shown for clearer understanding. Operating at high frequency, RF wireless devices can support high data transfer rate. However, for mouse or keyboard, we do not need to have high data rate. The only reason for a wireless mouse to use high frequency RF signal is because low frequency EM waves need to use large antennae. It is therefore a waste to use expensive RF systems to support most human interface devices such as a computer mouse.

FIG. 1(c) shows an example of a personal computer system equipped with an audio wireless key board (125) and an audio wireless mouse (127) of the present invention. The structures and fundamental functions of the audio wireless keyboard (125) and the audio wireless mouse (127) are nearly identical to the prior art devices (115, 117) in FIG. 1(b) except that these wireless devices communicate with the computer (101) through sound waves (126, 128). The computer (101) needs to have a microphone (121) that can detect sound waves (126, 128) transmitted from audio I/O devices (125, 127). It also may send out sound waves (124) to I/O devices. FIG. 1(c) shows an example of sound waves carrying a data string (129) where binary data ‘1’ is represented by higher frequency sound waves while binary data ‘0’ is represented by lower frequency sound waves. The actual data transfer protocols can be very flexible. The signals can be frequency modulated (FM), phase modulated (PM), represented by different frequency sub-bands, binary level, multiple levels, . . . , and so on; we can use similar signal modulation/transfer methods known for EM waves to support sound signals. To avoid creating bothering noise to humans, it is desirable to use sound waves at frequencies out of human hearing ranges (higher than 8K Hz or lower than 60 Hz). The microphone (121) converts received sound signals into electrical signals. These received signals are typically more complex then the emitted sound signals due to the effect of background noise, echo, distortion, reflection, . . . , and so on. Fortunately, current art signals processing methods are well developed to solve these problems. Signal processing for audio signals are actually by far simpler than RF signals because the frequency of sound waves is low enough to be handled by low cost circuits such as typical digital signal processing (DSP) hardware and software. It is even possible to use existing multi-carrier devices in most PCs to execute such signal processing procedures. Another advantage to handle sound signals is in the simplicity of filtering when the carrier frequency is limited within a few narrow frequency bands. In those cases, sound filters can be as simple as a string with adjustable length and strain or a tube with proper dimensions. For those familiar to the art, audio signal processing are similar but simpler than RF signal processing. The data transfer bandwidth available through sound waves is much narrower than that of RF EM waves, but its bandwidth is usually enough for human interface devices such as mouse or keyboards.

The methods of the present invention are different from prior art voice recognition methods because we use mechanical sound waves as signal carriers. Mechanical sound signals can be easily generated, detected, and analyzed by machines, and the properties of mechanical sound signals are consistent among different users. Human voice, although easily distinguishable by the human brain, is actually extremely complex for machines. Simple words like “yes” or “no” comprise very complex sound waveforms, and the spectrum is different when different people pronounce the same word at different time. To distinguish human voice with machines requires extremely complex calculations and comparisons, making it very expensive, and the results are often less than perfect.

Sound waves are actually excellent media to communicate with machines, if we use mechanical sound waves instead of complex human voice to communicate. FIG. 1(d) shows typical examples of the methods to use mechanical sound waves as signal carriers. The first example is an amplitude modulated (AM) sound wave that represents binary number ‘1’ by larger amplitude and binary number ‘0’ by smaller amplitude of a sound wave with simple spectrum. The second example is a phase modulated (FM) sound wave that represents binary number ‘1’ by one phase and binary number ‘0’ by opposite phase of a sound wave with simple spectrum. The phase difference is 180° for the FM example in FIG. 1(d) while actual implementation usually uses smaller phase differences. The third example is a frequency encoded (FE) sound wave (FE-1) that represents binary number ‘1’ by one frequency and binary number ‘0’ by a different frequency of a sound wave with simple spectrum. In our figures sound waves are represented by a set of line segments. Higher frequency sound waves are represented by higher density line segments while lower frequency sound waves are represented by low density line segments as shown in the next example (FE-2). The two frequency encoded waves (FE-1, FE-2) are the same waveforms represented in different drawing symbols. Similar drawing symbols (FE-2) in FIG. 1(c) are used to represent mechanical sound waves in other figures of the present invention. RF wireless systems also use similar frequency encoded signals. RF FE signals require accurate control (typically better than 1% range) of GHZ signals. FE signals of mechanical sound waves are by far easier to control. We can operate at much lower frequency, and we don't need to be very accurate in frequency control. For example, we can define binary ‘1’ for sound frequency between 2 MHZ to 4 MHZ, while binary ‘0’ for frequency between 1 MHZ to 500 KHZ. Such kinds of signals are extremely easy to handle with current art IC. We also can use mechanical sound waves that have more complex frequency spectrum. The fifth example (FE-3) in FIG. 1(d) is another type of frequency encoded (FE) sound signal. In this example, musical note ‘C’ is used to represent binary number ‘1’, while musical note ‘D’ is used to represent binary number ‘0’. We can certainly use any other musical nodes for the same purpose. Although the sound waveforms of musical notes can be rather complex compared to the simple waveforms shown in the above example, we consider musical notes as a type of “mechanical sound wave” because they can be easily generated, detected, and analyzed by machines with consistence. The key factor is consistency and ease in working with machines. The sixth example in FIG. 1(d) is a duty cycle modulated (DM) sound wave that represents binary number ‘1’ by larger positive duty cycle and binary number ‘0’ by smaller duty cycle of a sound wave with simple spectrum. The seventh example in FIG. 1(d) is a length modulated (LM) sound wave represents different data by different length of high amplitude sound waves in each data cycle. The eighth example in FIG. 1(d) is a interval modulated (IM) sound wave that represents binary number ‘1’ by larger waiting interval between sound pulses, and binary number ‘0’ by smaller waiting interval between sound pulses. Morse code, that represents human language by sound signals of different interval, is a clear example that we can use sound signals in consistent, globally recognizable ways. It certainly meets the definition of “mechanical sound signals” used by the present invention. It was too bad that Morse code was not used as wireless data transfer to control machines.

FIG. 1(d) lists a few examples of mechanical sound signals. There are wide varieties of methods to generate mechanical sound signals to be used as signal carriers for the present invention. The scope of the present invention should not be limited on particular methods and particular format of mechanical sound signals.

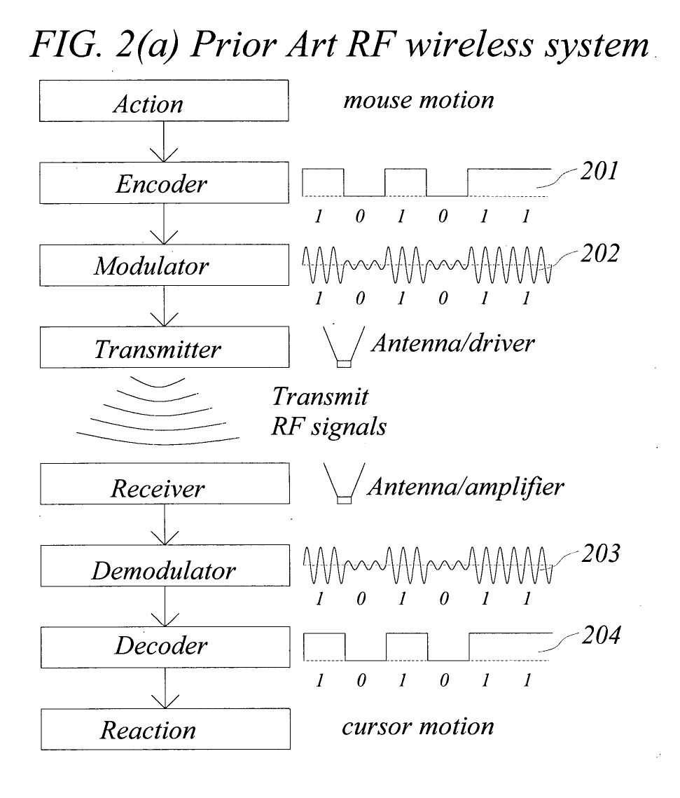

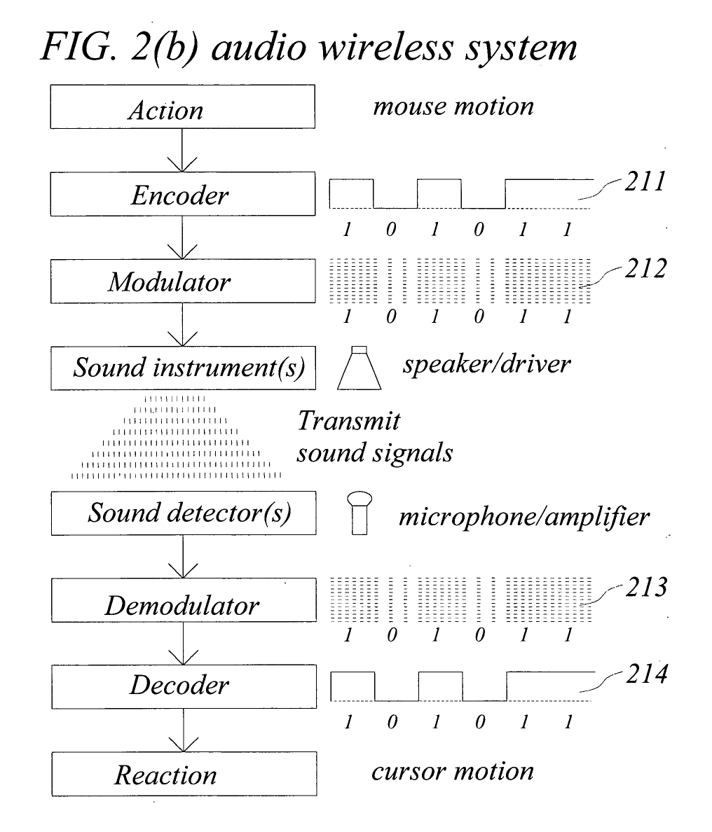

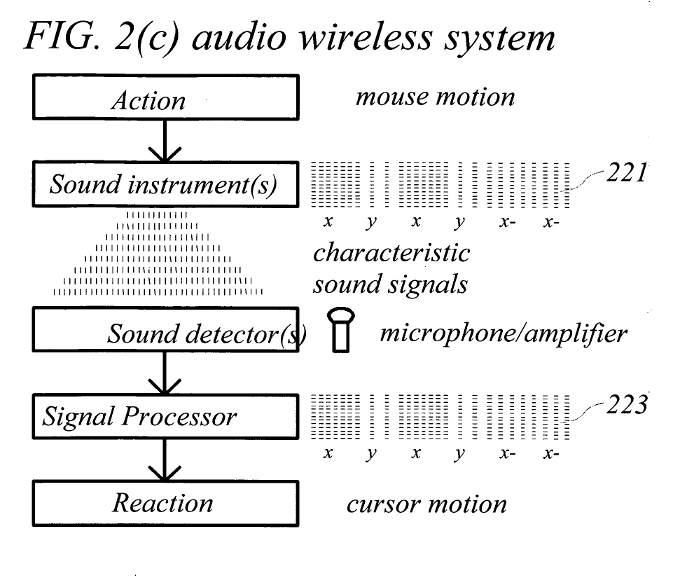

Most methods developed for RF signals are applicable to mechanical sound signals at lower cost. FIG. 2(a) illustrates typical signal transfer methods of prior art RF wireless systems. I/O actions (such as mouse motions) are translated into electrical signals by an encoder based on predefined protocols agreed between senders and receivers. FIG. 2(a) shows an example of encoded digital signal (201) where binary number ‘1’ is represented by high voltage while binary number ‘0’ is represented by low voltage. A modulator converts the encoded signals (201) into high frequency modulated signals (202) suitable for RF signal transfer. In this example, binary number ‘1’ is represented by larger amplitude while binary number ‘0’ is represented by lower amplitude. These modulated signals (202) are transmitted through RF EM waves by driving electrical currents to RF antenna. RF receivers equipped with antenna and amplifiers detect the transmitted RF EM waves. After removing the effects of noise, the received signals (203) should be a reproduction of the modulated signals (202). A demodulator uses the received signals (203) to extract binary electrical signals (204) that should be a reproduction of the encoded signals (201). Based on predefined protocols, the receiver calculates the I/O action (e.g. mouse motions) from the extracted signals (204) and executes proper reactions (e.g. cursor motions). The actual protocols and signal formats can be very complex. The above example shows an amplitude modulated (AM) signal, while actual signals can be frequency modulated (FM), phase modulated (PM), frequency encoded, . . . , and so on. The signal processing methods also can be very complex, involving amplification, filtering, equalization, error correction, echo canceling, digital signal processing, . . . , and so on. These methods are well known to those familiar with the art so that we will not discuss them in details. Simplified examples are shown here for clearer explanation.

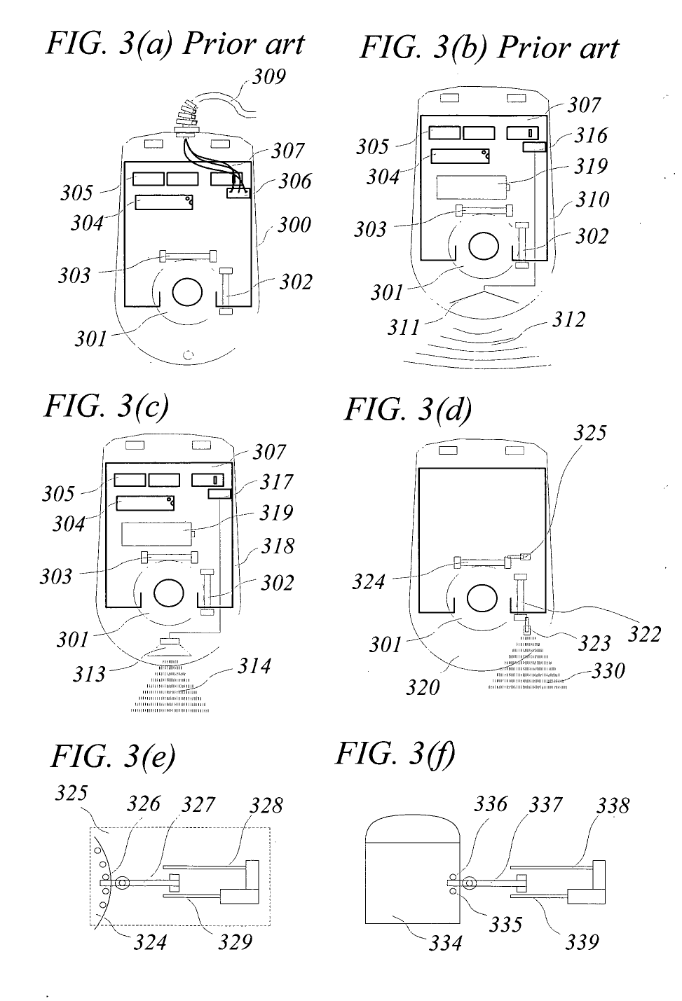

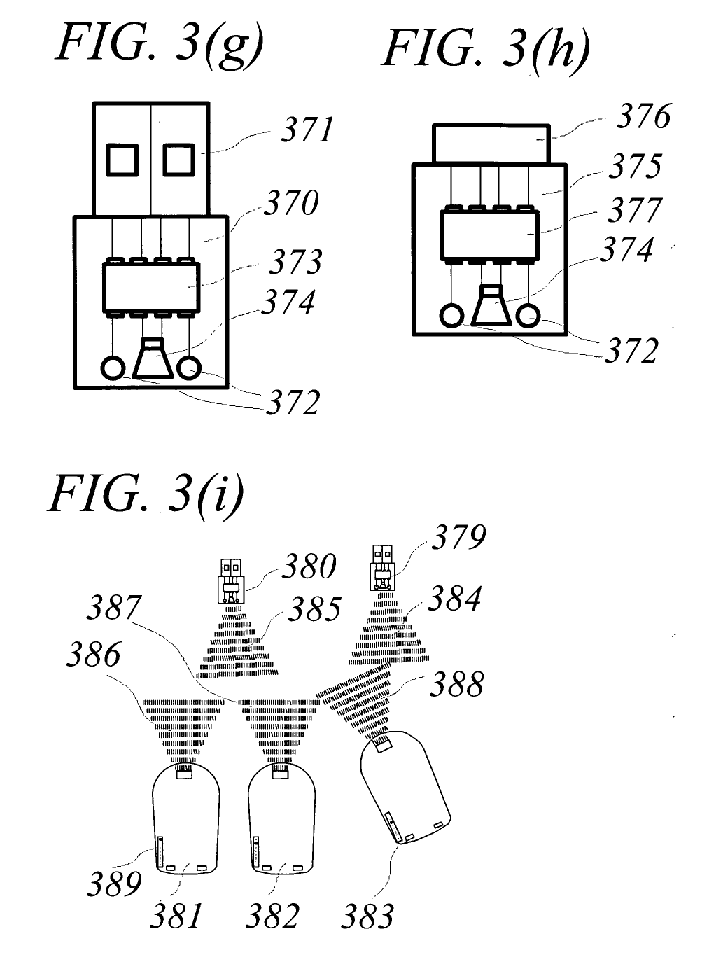

In comparison to the prior art RF transfer methods in FIG. 2(a), FIG. 2(b) illustrates typical signal transfer methods of the present invention. I/O actions (such as mouse motions) are translated into electrical signals (211) by an encoder based on predefined protocols agreed between senders and receivers. This step is identical to the prior art methods in FIG. 2(a). A modulator converts the encoded signals (211) into modulated signals (212) suitable for sound signal transfer. The principles used by this modulation step can be the same as prior art RF systems except that the carrier frequency is typically measured by MHZ or KHZ instead of GHZ. In this example, binary number ‘1’ is represented by higher frequency sound waves while binary ‘0’ is represented by lower frequency sound waves. These modulated signals (212) are transmitted through mechanical sound waves by driving one or more sound instruments such as speakers. The transmitted sound waves are detected by one or more sound detectors (such as microphones). After removing the effects of noise, the received signals (213) should be a reproduction of the modulated signals (212). A demodulator uses the received signals (213) to extract electrical signals (214) that should be a reproduction of the encoded signals (211). Based on predefined protocols, the receiver calculates the I/O action (e.g. mouse motions) from the extracted signals (214) and executes proper reactions (e.g. cursor motions). Almost all the methods used in this example are identical to those in FIG. 2(a) except that the signal carriers are sound waves instead of RF EM waves. This means that we can utilize almost all the well-developed prior art technologies, protocols, software, circuits, . . . , etc, to support wireless operations of the present invention, while all the operations are more cost efficient and easier to execute because the frequency of sound carrier signals are by far lower than the frequency of RF signals. The above example shows a frequency encoded signal, while actual signals can be amplitude modulated (AM), phase modulated (PM), . . . , and so on. The signal processing methods also can be very complex, involving amplification, filtering, equalization, error correction, echo canceling, digital signal processing, . . . , and so on. Since almost all of those methods are the same as prior art methods except the signal transfer carrier, we will not discuss them in details. Simplified examples are shown here for clearer explanation. Comparison between prior art devices and devices of the present invention is illustrated in further details by the examples shown in FIGS. 3(a-c).

Wireless devices using the methods in FIG. 2(b) require batteries to support its electrical operations. FIG. 2(c) illustrates signal transfer methods of the present invention that do not need batteries. I/O actions (such as mouse motions) stimulate characteristic mechanical sound signals (221) through sound instruments such as vibration plates or whistlers. For example, a high frequency sound pulse shows a unit mouse motion along x direction, a low frequency sound pulse shows a unit mouse motion along y direction, and a medium frequency sound pulse shows a unit mouse motion along opposite x direction as illustrated by the example (221) in FIG. 2(c). Such sound signals are detected by sound receivers equipped with detector(s) and amplifiers. After removing the effects of noise, the received signals (223) should be a reproduction of the transmitted signals (221). A signal processor uses the received signals (223) to calculate the I/O action (e.g. mouse motions). This type of application is discussed in further details by the example shown in FIGS. 3(d-f).

Applications of the above methods are demonstrated by practical examples of computer mice shown in FIGS. 3(a-p). FIG. 3(a) shows simplified structures of a prior art mechanical mouse (300). This mouse uses a tracking ball (301) to detect mouse motion. Two rollers (302, 303) placed vertical to each other allow separated measurements in horizontal motion and in vertical motion. An integrated circuit controller (304) and several supporting electrical components (305) converts roller motions into electrical signals. A driver chip (306) sends the electrical signals to computer through electrical wires (307) wrapped in a cable (309). FIG. 3(b) shows simplified structures for a prior art wireless mouse. This mouse (310) uses the same tracking ball (301), rollers (302, 303), IC controller (304), and supporting electrical components (305) as those of the wired mouse (300) in FIG. 3(a). The difference is that this wireless mouse has an RF IC (316) that converts electrical signals originally sent through wires into modulated RF EM waves (312) emitted from an RF antenna (311). This mouse (310) communicates with a computer through RF signals according to the procedures in FIG. 2(a), so that it is no longer limited by wires (307, 309), and the user can enjoy the convenience of wireless devices.

FIG. 3(c) shows simplified structures for a mouse of the present invention for comparison. This mouse (318) uses the same tracking ball (301), rollers (302, 303), IC controller (304), and supporting electrical components (305) as those of the prior art mice (300, 310). The difference is that this mouse (318) has an audio IC (317) that converts electrical signals originally sent through wires (307) or RF signals (312) into modulated sound waves (314) emitted from a sound speaker (314). This mouse (318) communicates with a computer through sound waves according to the procedures in FIG. 2(b), so that it is no longer limited by wires (307, 309), and the user can enjoy the convenience of wireless devices. In the mean time, audio components (317, 313) are much easier to manufacture than RF components (316, 311) so that the audio mouse (318) is more cost efficient than the RF mouse (310). The above examples in FIGS. 3(a-c) demonstrate the possibility to build audio wireless devices of the present invention while using most existing components with minimum changes. Further savings are achievable as demonstrated in the following examples.

The wireless mouse in FIG. 3(b,c) needs to have batteries (319) to supply the power for electrical operations. The mouse (320) shown in FIG. 3(d) uses the same tracking ball (301) as prior art mouse and modified rollers (322, 324), while roller motions are directly converted into sound signals without using electrical components. The edges of the rollers (322, 324) are equipped with sound generating devices (323, 325). The structures for one of the sound generating device (325) are magnified in FIG. 3(e). The edge of the roller (324) has markers (326) distributed in proper distances. These markers (326) swing a hammer (327) that strikes a pair of vibration plates (328, 329). When the markers (326) are moving from up to down, the hammer (327) strikes the upper vibration plate (328), which sends out a characteristic sound signal (330) according to the dimension of the vibration plate (328). When the markers (326) are moving from down to up, the hammer (327) strikes the lower vibration plate (329), which sends out a characteristic sound signal that is different from the characteristic sound of the upper plate (328), and signal for both the direction and the distance of mouse motion. The motion of a mouse button can be detected in a similar mechanism as illustrated in FIG. 3(f). The edge of a button (334) has two markers (335, 336). These markers swing a hammer (337) that strikes a pair of vibration plates (338, 339). When the button (334) is pushed downward, the hammer (337) strikes the upper vibration plate (338), which sends out a characteristic sound signal. When the button (334) is released back up, the hammer (337) strikes the lower vibration plate (339), which sends out different characteristic sound signals. In these ways, mouse motion and button status are signaled by different types of characteristic sound signals. Using the methods described in FIG. 2(c), the mouse (320) can support all the functions of prior art mice (300, 310). Since there is no electrical component used for this mouse (320), it does not need to use any battery.

While specific embodiments of the invention have been illustrated and described herein, it is realized that other modifications and changes will occur to those skilled in the art. The examples in FIGS. 3(a-f) are mechanical mice, while similar structures are equally applicable to an optical mouse or other types of computer I/O devices. There are wide varieties of method in generating and processing sound signals. Similar principles are applicable to other devices such as key boards and many other applications. The detailed physical structures can be implemented in wide varieties of structures.

The audio wireless computer mice described in the above examples require controllers equipped with sound detectors to analyze the sound signals and to execute proper reactions such as cursor motions. One method is to use a personal computer equipped with microphone(s) as the mouse controller as shown in FIG. 1(c). Such computers will need to have supporting software (called “driver” in current art terminology) written for audio mice of the present invention. Since computer mouse of the present invention is still new to the market, most of existing computers do not have proper driver software to support needed operations. It is therefore desirable to bypass this barrier by providing controllers that make devices of the present invention fully compatible with existing systems. FIG. 3(g) shows the structures for a mouse controller (370) of the present invention. One side of this mouse controller (370) comprises a USB interface (371) that is identical to the USB interface of prior art wired mouse. The other side of the mouse controller comprises sound detector(s) (372) to receive sound signals emitted from audio mice of the present invention. An integrated circuit chip (373) analyzes the sound signals from sound detectors (372) to determine mouse activities as shown by the above examples. This IC chip (373) also converts the audio mouse activities into USB bus signals that are fully compatible with prior art wired mouse. The controller (370) also can have an optional speaker (374) that can send out sound signals to audio mice. When this controller (370) is plugged into one of the USB interface of a current computer to work with audio mice of the present invention, the computer will see exactly the same interface signals as prior art wired mouse. A current art computer is therefore able to use audio mice without any changes. The IC chip (373) need to have circuits that can analyze sound signals, logic circuits that can execute needed calculation, and USB bus interface control circuits. All of those circuits are well-known circuits. IC designers familiar with these fields will be able to design such chips upon disclosure of the present invention.

Many old style computer mice do not use the USB interface. Instead, they may use the serial bus of old computers. To support those old style computers, we can have a controller (375) that supports serial bus (376) interface as shown in FIG. 3(h). The IC chip (377) of this controller (375) needs to be able to support serial bus interface in ways that are fully compatible with old style serial mouse. IC designers familiar with these fields will be able to design such controller IC, or even an IC that can support multiple types of compatible interfaces upon disclosure of the present invention.

Audio wireless mice of the present invention allow flexibility for multiple mice to communicate with one controller, and for one mouse to communicate with multiple controllers. Such flexibility is extremely useful for information sharing in a conference. FIG. 3(i) demonstrates such multiple tasking capabilities. A plurality of audio wireless mice (381, 382, 383) use characteristic sound signals (386, 387, 388) to communicate with a plurality of audio wireless controllers (379, 380). These controllers (379, 380) also can emit sound signals (384, 385) to communicate with those audio wireless mice (381, 382, 383). The center frequency of the sound carrier signal can be adjusted by a jumper (389) on each device so that the signals emitted from each device can use different ranges of sound signal frequencies (called “channel” in the art of wireless communication) to avoid interference. It is also possible to use location tracking capability to separate signals emitted from different devices. The resulting systems allow multiple users to share computers and I/O resources simultaneously, providing excellent communication in conferences or in classrooms.

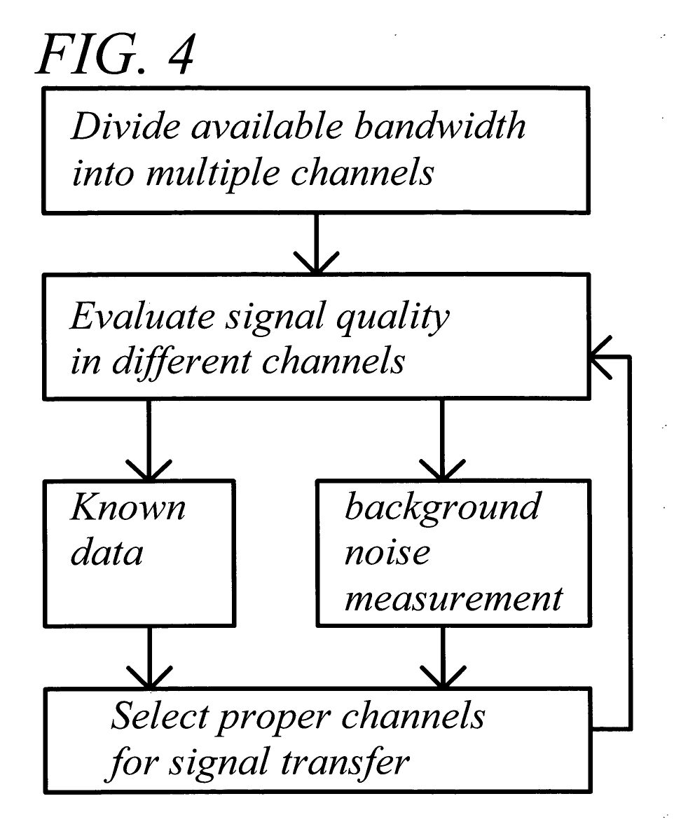

The multiple user system shown in FIG. 3(g) requires special care to avoid noise effects and interference between different users. Noise and interference problems have been heavily studied for prior art teleconference systems. Devices of the present invention certainly can adapt existing solutions for such problems. In addition, FIG. 4 shows a method that has been found to be very effective. First, we divide available bandwidth into multiple channels. Each channel has enough bandwidth to carry desired operations. Next, the system uses spare time to evaluate signal quality in different channels. We can search all channels to find the best few channels. We also can search a few channels to find those that are “good enough”. There are many methods to define the quality of a channel. One method is to emit a known data pattern. Since the receivers know the right answer, we can compare the results from the right answer and measure the quality of a channel. Another method is to create a “quiet period” when there is supposed to have no signal transmission, and measure the background noise. The smaller the noise, the better the quality of the channel. We certainly can use a combination of both methods or add other methods until we can select proper channels for all users in the system. These procedures can be repeated every once in a while to assure continuous quality of the system.

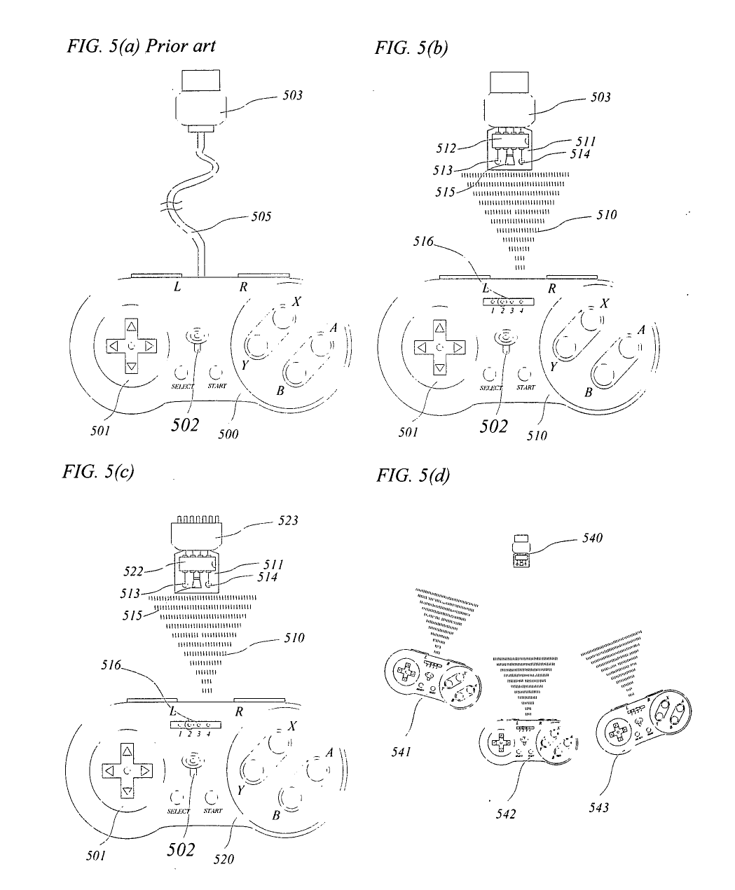

While specific embodiments of the invention have been illustrated and described herein, it is realized that other modifications and changes will occur to those skilled in the art. The above examples use computer mice to demonstrate operation principles of the present invention, while similar methods can be applied to wide varieties of applications. For examples, those familiar with the art can easily build wireless video game controllers as shown in FIGS. 5(a-d).

Game controllers are simple human interface devices operating at slow data rate at short ranges; they are typical applications that should be supported by the present invention. Currently, Playstation, Nintendo, and Xbox are the dominating brands for video game market. Game controllers used by each brand are not exactly the same, but they all have the same basic structures. FIG. 5(a) shows the structures for a typical prior art game controller (500) that comprises basic control components such as a plurality of buttons (A, B, X, Y, L, R, select, start, . . . ), a control panel with directional buttons (501), and a joy stick (502). Some controllers support more joy sticks; some have more or less buttons. The controller 500 is connected to a game box (not shown) through a wire (505) and a socket (503). There are wireless game controllers that use an RF interface to replace the wire (505). Game players push these components (buttons, panel, joy stick), and the controller (500) sends electrical signals to the game box indicating which component has been pushed, and the game box response accordingly.

FIG. 5(b) shows a wireless game controller (510) of the present invention. This game controller (510) has the same control components (buttons, panel, joy stick) as the prior art controller in FIG. 5(a), and it uses the same socket (503) to connect with game box. The major difference is that this controller (510) sends signals through characteristic mechanical sound signals (519). An adaptor (511) is attached to the socket (503) that comprises sound detectors (513, 514), control IC chip (512), and an optional speaker (515). This adaptor (511) translates the characteristic mechanical sound signals (519) emitted by the controller (510) and converts the signals into the same electrical signals as the prior art wired controller (500). It is therefore fully compatible with prior art game controllers. An optional selection switch (516) allows the user to select different sound communication channels for multiple user applications. The basic operations for such game controllers are very similar to computer mice; game controllers have more buttons than computer mice but they are actually easier to support because we do not need to support motion detections. FIG. 5(c) shows another game controller (520) of the present invention used to support different brand of game box (not shown). This game controller (520) is identical to the one in FIG. 5(b) except that it is using a different socket (523) to interface with different brand of game box. The IC chip (522) also needs to be able to provide electrical signals in the right format. Those familiar with IC design will be able to design an IC chip (522) that can support all the major brands of game boxes. In that case, all we need to do is to change the socket (523) for different brand, and game controllers of the present invention will be able to support all major brands. It is also possible to put the adaptor (511) into game boxes; in that way we no longer need to use sockets (503, 523).

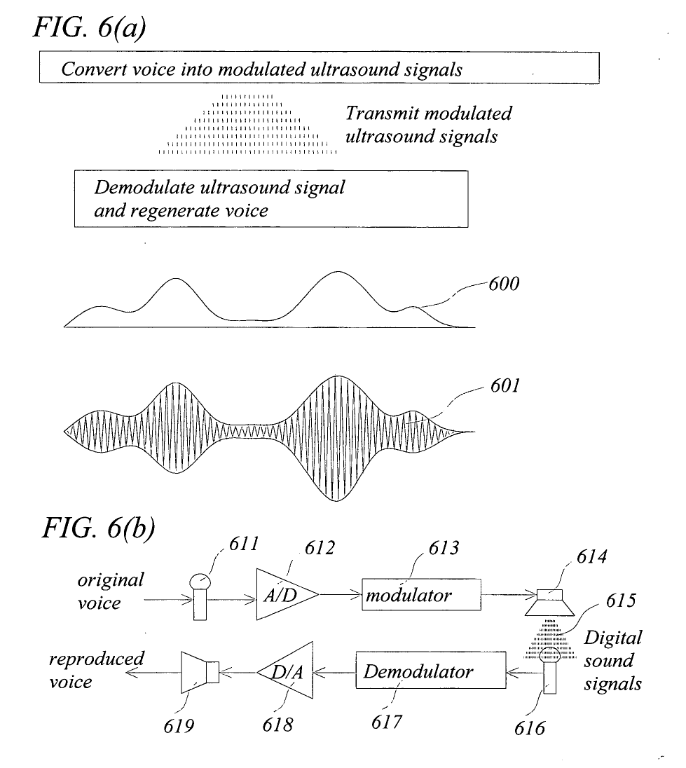

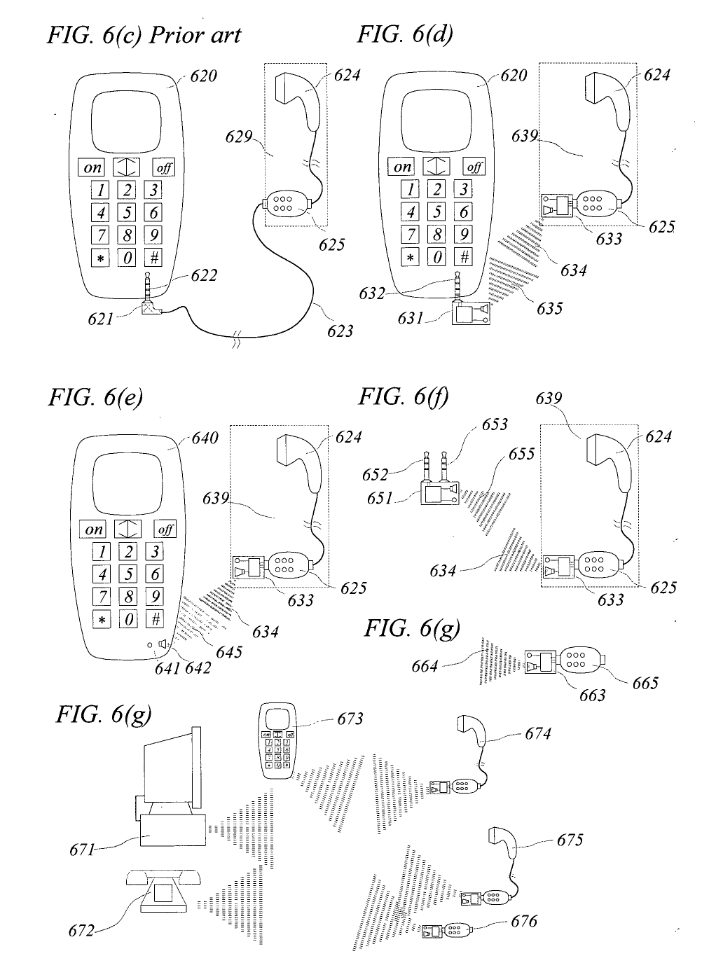

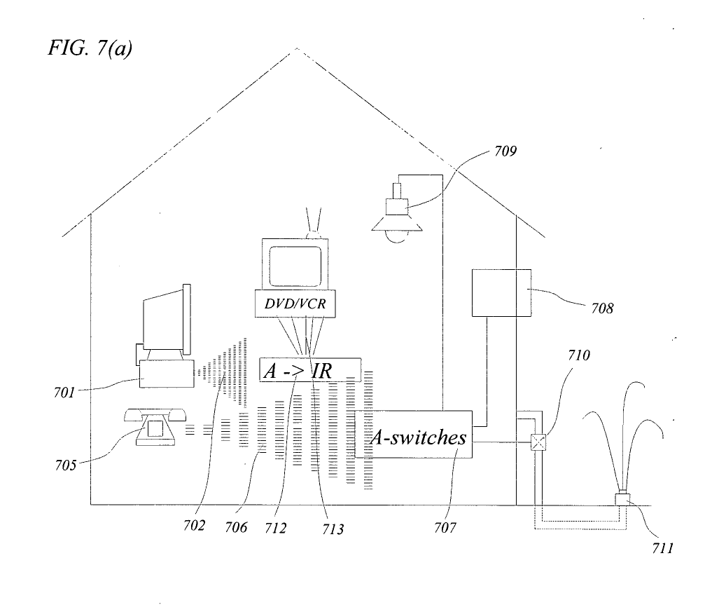

The present invention is different from prior art voice recognition system because we do not analyze complex human voice as a method to control machines. Interestingly, we can use mechanical sound waves to carry human voice for applications such as wireless telephones or wireless microphones. In such applications, human voices are treated as data, not as control signals. Prior art wireless phones use RF signals to carry voice signals between headset and telephone set. We can replace the RF interface with ultrasound signals to carry voice signals. The operation methods for the wireless phones of the present invention are illustrated in FIG. 6(a). Human voice is modulated into ultrasound signals in similar ways as prior art RF wireless phone use RF signals. FIG. 6(a) shows an example voice waveform (600) that is carried by an AM ultrasound waveform (601). The ultrasound signals are transmitted and received by a receiver that can demodulate the voice out of the modulated ultrasound signals. Such ultrasound wireless phones function as well as RF phones while they are more cost efficient because ultrasound waves are much easier to process than RF signals. Beside AM modulation, we certainly can use other modulation methods (such as FM methods) that are well known to those familiar to the art. To have better voice quality, we also can digitize the voice signals as shown in FIG. 6(b). The original voice is translated into electrical waveform (600) by a microphone (611). The electrical wave form is digitized into binary digital numbers by an analog-to-digital (A/D) converter (612). The resulting digital numbers are modulated into mechanical sound signals (615) emitted by a speaker (614). A sound detector (616) receives the sound signals (615) and a demodulator (617) converts the signals (615) back into the same digital numbers. A digital-to-analog (D/A) converter converts the digital numbers back into sound waveform, and a speaker (619) reproduce the original voice. All the components used by these methods are well-known components. Upon disclosure of the present invention, it will be readily implemented by those familiar with the art.

The methods described in FIG. 6(a,b) are applicable to any kind of voice devices. FIG. 6(c) shows the structures of a prior art cellular phone (620) equipped with a wired headset (629) that comprises an earphone (624) and a microphone (625). This headset (629) is connected to the cellular phone (620) through a wire (623) and a socket (621). The socket has a 2.5 mm plug (622) to support both the earphone (624) and the microphone (625) using the same socket (621). Most people use cellular phone headsets to avoid RF radiation into brain. RF wireless headset for cellular phone is therefore not desirable because it will also cause radiation problems. However, we can provide wireless headset using sound signals of the present invention as illustrated in FIG. 6(d). There is no need to change anything in the cellular phone (620) or headset (639); all we need is an ultrasound interface between them. An interface device (631) is connected to the socket (632) plugged into the cellular phone (620). Another interface device (633) is connected to the headset (639). These interface devices (631, 633) have sound detectors, control IC chips, and sound speakers. They operate in similar ways as those used for computer mice or game controller interfaces shown in previous examples while the only difference is that they have interface logic to communicate with voice devices (earphone and headset). These interface devices (631, 633) can have their own sound sensors and sound instruments, they also can use the built-in sound devices in the headset (639) or in the cellular phone (620). Those familiar with the art will be able to build these interface devices (631, 633), so that we will not discuss their structures in further details here. The cellular phone interface device (631) converts the voice signals from cellular phones (620) into ultrasound signals (635) based on methods described in FIG. 6(a) or FIG. 6(b) to communicate with the headset interface device (633). The headset interface device (633) receives the modulated sound signal (635) and converts it into electrical signals compatible to prior art electrical signals to the headset (639). Similarly, the headset interface device (633) converts the voice signals from headset (639) into ultrasound signals (634) based on methods described in FIG. 6(a) or FIG. 6(b) to communicate with the cellular phone interface device (631). The cellular phone interface device (631) receives the modulated sound signal (634), and converts it into electrical signals identical to prior art electrical signals to the cellular phone (620). This wireless headset (329) of the present invention is therefore fully compatible with prior art wired headset.

Prior art cellular phones are already equipped with microphone, speaker, and signal processing capability. With proper modifications (in many cases, we only need to modify software without modifying hardware), a typical cellular phone is fully capable of supporting all the operations needed to communicate with devices of the present invention. FIG. 6(e) illustrates a case when the same headset interface device (633) in FIG. 6(d) directly communicates with a cellular phone (640). This cellular phone (640) uses its built-in speaker (642) to send modulated sound signals (645) to the headset (639). It also use its built-in sound detector (641) to receive signals (634) sent from the wireless headset (329). The signal processing capabilities of typical cellular phones are enough to handle all the necessary procedures. In this way, we no longer need the interface device (631) and the socket (632) in FIG. 6(d).

Besides cellular phones, headsets of the present invention also can provide wireless communication to many other types of appliances such as personal computers or telephone stations. FIG. 6(f) shows an adaptor (651) that allows a headset (639) of the present invention to communicate with personal computers. Personal computers typically use separated 3.5 mm plugs (652, 653) to interface with wired microphone and wired ear phone. The adaptor (651) provides two 3.5 mm plugs to interface with computers while the rest of its structures and functions are nearly identical to the cellular phone interface device (631) shown in FIG. 6(d). The adaptor (651) and the headset (639) provide wireless communication that is fully compatible with prior art wired devices. We certainly can modify the computer software to allow wireless communication between the headset (329) and a computer without the adaptor (651) but that would not be fully compatible with existing systems. The same adaptor (651) also can provide wireless communication for radios, tape recorders, and many other appliances. If we remove the ear phone (624) from the headset (639), the resulting device is a wireless microphone (665) of the present invention. This wireless microphone can be manufactured in very small size, and it is extremely convenient to use. Besides 2.5 mm or 3.5 mm plugs, we certainly can support other types of interface standards such as USB interface to computers, RCA plugs, coaxial cables, simple audio cables, . . . etc. based on similar principles.

Wireless voice devices of the present invention can support multiple users simultaneously as illustrated by FIG. 6(g). A plurality of headsets (674, 675) and microphones (676) can simultaneously communicate with a plurality of cellular phones (673), computers (671), telephone sets (672), . . . , and so on, using wireless signals of the present invention. Such systems are extremely useful in conferences or classrooms. We also can use the methods in FIG. 4 to improve the quality of the voice for such applications.

While specific embodiments of the invention have been illustrated and described herein, it is realized that other modifications and changes will occur to those skilled in the art. For example, the audio wireless head sets of the present invention also can work with radio, TV, or any kind of appliance with voice interfaces.

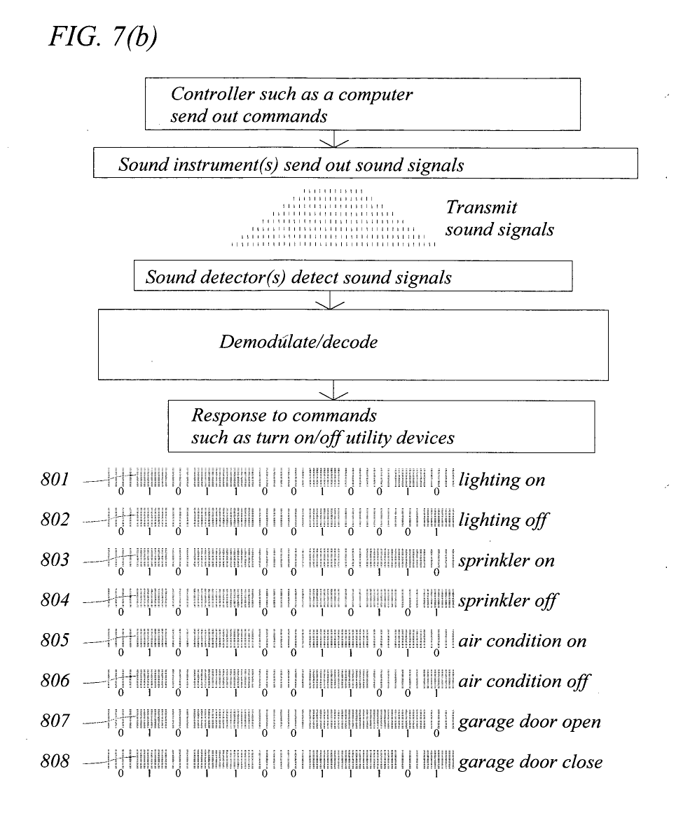

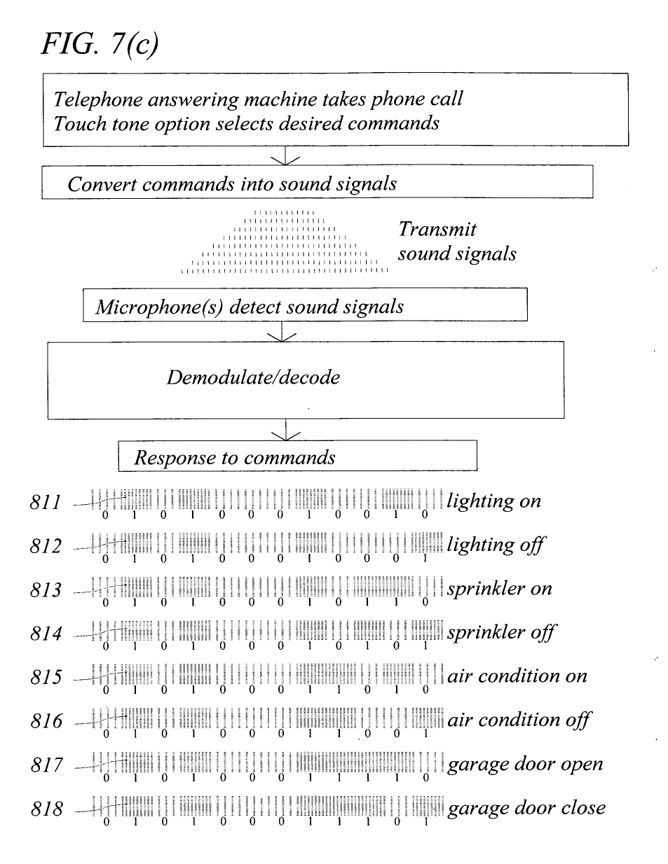

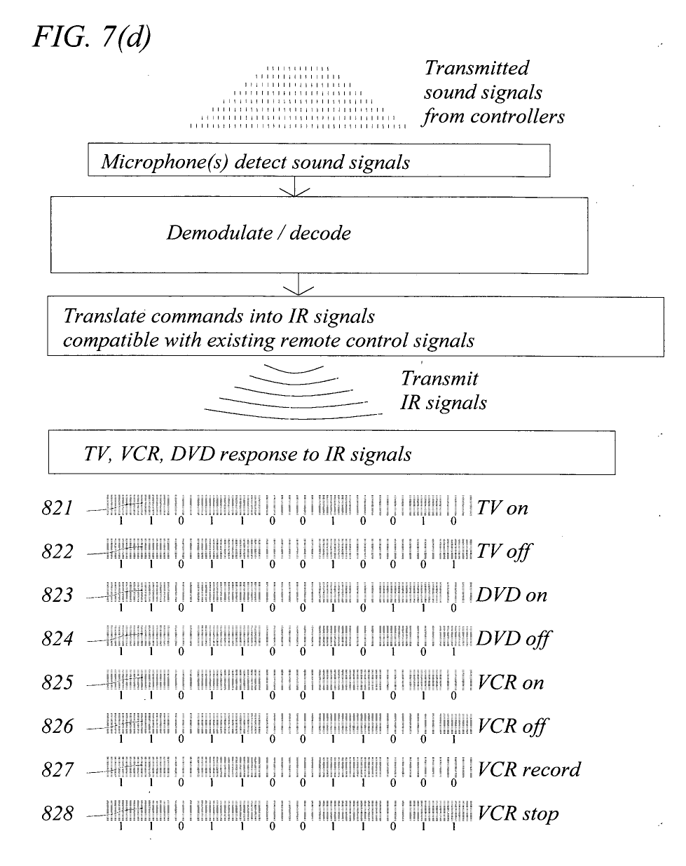

Sound signals of the present invention are ideal to support low data rate short range operations such as the household applications illustrated in FIG. 7(a). In a common house, a controller such as a personal computer (701) equipped with audio wireless device of the present invention will be able to control most household appliances. For example, the computer (701) can send out mechanical sound signals (702) to an audio switch box (707) to control lighting (709), air conditioning (708) or the water valve (710) of a sprinkler system (711). The float chart in FIG. 7(b) shows the control procedures for the audio switch box (707). Controllers such as a control circuit or a personal computer equipped with utility software determine the type and the time that household operations need to happen. The controller sends out commands by converting the commands into mechanical sound signals. An appliance equipped with one or more sound detectors (such as microphones) receive the command and respond to the commands to turn on or turn off household appliances. FIG. 7(b) also shows examples for the sound signals (801-808) of the above application. In these examples, binary ‘1’ is represented by higher frequency sound waves (represented by denser patterns) while binary ‘0’ is represented by lower frequency sound waves (represented by less dense patterns). The audio switch box (707) in FIG. 7(a) is equipped with electrical circuits that can detect and decode such signals and execute commands accordingly. The first example sound waves (801) represent a 12-bit binary code ‘010110010010’. In this example, the first 8 bits ‘01011001’ represents an identification (ID) code telling the audio switch box (707) this is a command for it. The next two bits ‘00’ tell the switch box this command is to determine the status of lighting switch, and the last two bits ‘10’ tell the switch box to turn on the switch. Therefore, the first sound wave example (801) commands the switch box (707) to turn the lighting (709) system on. The second example of sound waves (802) represents a 12-bit binary code ‘010110010001’, where the meanings of the first 10 bits are the same as the first example (801) while the last two bits ‘01’ tell the switch box to turn off the switch. Therefore, the second example sound waves (802) command the switch box (707) to turn the lighting (709) system off. The third example of sound waves (803) represents a 12-bit binary code ‘010110010110’, while the first 8 bits ‘01011001’ still is the ID code of the audio switch box (707). The next two bits ‘01’ tell the switch box this command is to determine the status of sprinkle system valve (710), and the last two bits ‘10’ tell the switch box to turn on the switch. Therefore, the third sound wave example (803) commands the switch box (707) to turn on sprinkler systems (711). The forth example of sound waves (804) represents a 12-bit binary code ‘010110010101’, where the meanings of the first 10 bits are the same as the third example (803) while the last two bits ‘01’ tell the switch box to turn off the switch. Therefore, the forth example sound waves (804) command the switch box (707) to turn off the sprinkler systems (711). The fifth example of sound waves (805) represents a 12-bit binary code ‘010110011010’, while the first 8 bits ‘01011001’ still is the ID code of the audio switch box (707). The next two bits ‘10’ tell the switch box this command is to determine the status of air condition machine (708), and the last two bits ‘10’ tell the switch box to turn on the switch. Therefore, the fifth sound wave example (805) commands the switch box (707) to turn on air condition machine (708). The sixth example of sound waves (806) represents a 12-bit binary code ‘010110011001’, where the meanings of the first 10 bits are the same as the fifth example (805) while the last two bits ‘01’ tell the switch box to turn off the switch. Therefore, the sixth example sound waves (806) command the switch box (707) to turn off the air condition machine (708). The seventh example of sound waves (807) represent a 12-bit binary code ‘010110011110’, while the first 8 bits ‘01011001’ still is the ID code of the audio switch box (707). The next two bits ‘11’ tell the switch box this command is to determine the status of garage door (not shown), and the last two bits ‘10’ tell the switch box to turn on the switch. Therefore, the seventh sound wave example (807) commands the switch box (707) to open garage door. The eighth example of sound waves (808) represents a 12-bit binary code ‘010110011101’, where the meanings of the first 10 bits are the same as the seventh example (807) while the last two bits ‘01’ tell the switch box to turn off the switch. Therefore, the eighth example sound waves (808) command the switch box (707) to close the garage door. These examples can go on and on while the signals can be more complex to control more switches or more complex operations. Individual appliances also can accept separated commands. It should be obvious that wireless control methods of the present invention are by far simpler than prior art voice recognition methods. The human voice for the simple word “yes” is about 1 second of extremely complex sound waves that are different when different people say it. A binary number ‘1’ represented by sound waves of the present invention takes less than one milliseconds while the waveform can be identical all the time. It is therefore by far more efficient to use sound waves as signal carrier instead of using prior art voice recognition systems. RF wireless systems can achieve the same functions but its supporting circuits are by far more complex due to its GHZ frequency. Therefore, the present invention provides the best options for low data rate operations.

Besides using computers, there are many other ways to send out commands through sound waves. FIG. 7(a) also shows an example when a telephone (705) is used to send sound signals (706) to control appliances. FIG. 7(c) describes the float chart for the procedures to use telephone as controller of the present invention. This telephone (705) is similar to a prior art telephone answering machine. The user can use touch tone to select options as prior art telephone except some of the options allow the telephone to send out characteristic sound signals (706) for controlling appliances. An appliance equipped with sound detectors receives the command and respond to the commands to execute different functions. The following is an example for “conversation to machine” through such telephone (705).

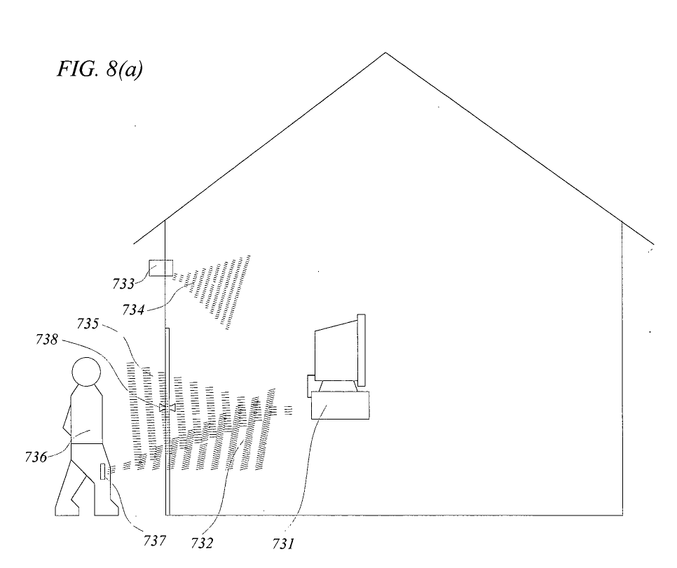

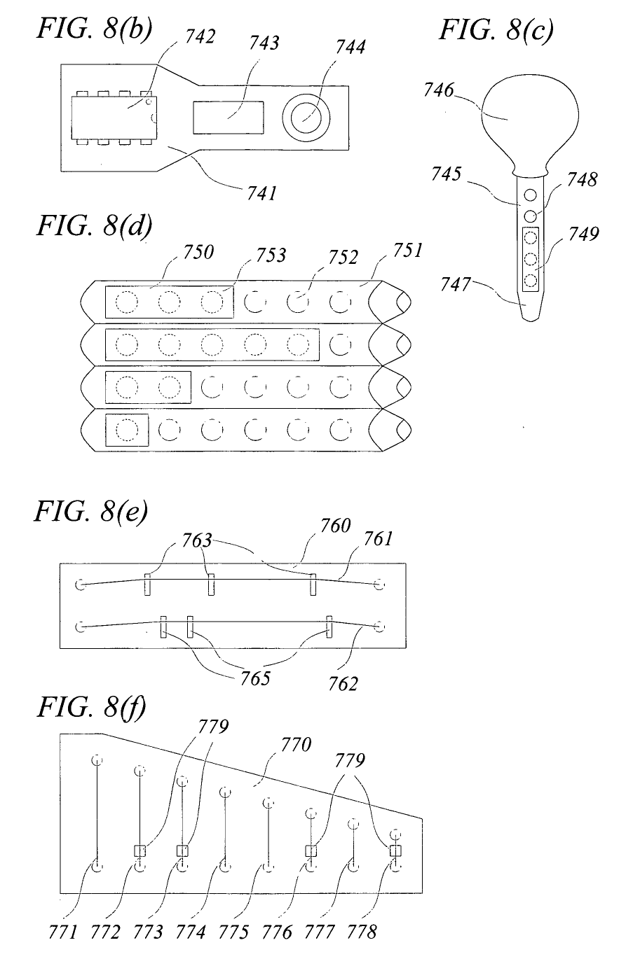

A user dials the phone number to a telephone (705) of the present invention, and the answering voice says “please dial 1 if you want to leave a message to John, dial 2 if you want to leave a message to Mary, and dial 3 for household control system”. The user dials 3, and the voice replies “please dial your password to access household control system”. The user dials in a pass word such as ‘13589’, the machine verifies that pass word, and replies “The pass word is correct, please dial the machine ID number”. The user dials ‘01010001’, and the machine says “that is a valid ID code for utility switch box number 3, please dial in switch number and action code”. The user dials ‘0110’, and the machine answers “please confirm that you want to turn on the sprinkler system”. The user dials ‘1’ to confirm, and the telephone (705) send out sound waves (706) to the audio switch box (707) which follows the command to turn on the sprinkler system (711). FIG. 8(b) also shows examples for the sound signals (811-818) of the above application. These example sound signals (811-811) are almost identical to those in FIG. 8(a) except there is one bit (fifth bit) different in the ID code (the first 8 bits of the command). The ID code in FIG. 8(a) is ‘01011001’ while the ID code in FIG. 8(b) is ‘01010001’. We assume that the audio switch box (707) is able to respond to both ID codes while knowing ‘01011001’ means the command comes from the computer (701) and ‘01010001’ means the command comes from the telephone (705). It is very important to verify the identification of the user for security reasons. Otherwise an intruder will be able to use any telephone to access household control. The above example uses password for security check. It maybe desirable to use more complex security checks such as a password in combination with the timing of the dialing strokes. For example, dialing ‘13589’ is not enough, the user needs to dial ‘1--3-58---9’ where ‘-’ represents the length of waiting time between each number. The telephone should also hang up if a caller tried multiple failed passwords because that caller is likely to be an intruder.

Some appliances such as television (TV), digital video disk (DVD) drivers, video tape recorders (VCR), may have existing wireless control system such as infrared (IR) remote control. Although we can change the remote control mechanism of those appliances to receive sound signals, we also can use its existing control methods by providing a converter (712) that converts the sound signals (702, 706) transmitted by controllers of the present invention (701, 705) into corresponding command signals, in this example, IR remote control signals (713), of existing appliances. FIG. 7(d) is a float chart shows the methods for such converter (712). The converter receives the transmitted sound signals from controller, and uses microphone(s) to convert the sound signals into electrical signals. The electrical signals are processed by signal processing methods to remove noise effects, and the converter (712) translates the commands into corresponding IR remote control commands such as change TV channel or start a VCR record operation. The command is converted into IR signals recognizable to prior art IR remove control receivers already in the appliances so that those appliances can response to the commands. FIG. 7(d) also shows examples for the sound signals (821-828) of the above application. The audio-to-IR converter (712) in FIG. 7(a) is equipped with electrical circuits that can detect and decode modulated signals and execute commands accordingly. The first example of sound waves (821) represents a 12-bit binary code ‘110110010010’. In this example, the first 8 bits ‘11011001’ represents an ID code telling the audio-to-IR converter (712) that it should respond to the command. In the mean time, the ID code also tells the audio switch box (707) not to respond to the commands. The next two bits ‘00’ tell the converter this command is to determine the status of TV switch, and the last two bits ‘10’ tell the converter (712) to send out IR remote control signals (713) to turn on the TV. Therefore, the first sound wave example (821) in FIG. 8(c) commands the converter (712) to turn on TV by sending corresponding IR remote control signals to TV. The second example of sound waves (822) represents a 12-bit binary code ‘110110010001’, where the meanings of the first 10 bits are the same as the first example (821) while the last two bits ‘01’ tell the converter to turn off TV by sending corresponding IR remote control signals to TV. The remaining example waveforms (823-828) control DVD and VCR operations based on similar principles. These examples can go on and on while the signals can be more complex to control sophisticated operations.

While specific embodiments of the invention have been illustrated and described herein, it is realized that other modifications and changes will occur to those skilled in the art. The present invention uses modulated sound waves carrying digital signals to support wireless operations. There are unlimited applications and wide variations of methods to implement devices of the present invention. We used simple waveforms as examples to demonstrate operation principles of the present invention. There are unlimited ways in implementing actual waveforms. Sound signals of the present invention provide the most efficient options for many types of wireless applications. FIG. 8(a) shows examples for the applications in security systems. A house is equipped with a motion detector (733). This motion detector (733) uses mechanical sound signals (734) to notify a controller (731) that a person (736) is approaching the house. The controller (731) sends out sound signals (735) toward the approaching person (736) asking for identification. In this case, the sound signals (735) can be human voice (to communicate with the person (736) or mechanical sounds signals (to communicate with the audio key). An audio key (737) carried by the person (736) sends out sound signals (732) as ID to the controller (731). When the ID is verified, the door (738) is unlocked and the person is welcomed. If the ID is not verified, the system will send out warnings to expel the approaching person (736). All the components required to build the above security system are well-known to those familiar with current art except the methods to communicate with mechanical sound signals and the methods to build the audio key (737) of the present invention. FIGS. 8(b-f) show several examples for the audio keys of the present invention. FIG. 8(b) shows an audio key (741) that comprise an integrated circuit (IC) chip (742) and a sound instrument (743). The sound instrument (743) can be a simple vibration plate. When the audio key (741) receives a notice for identification (push a button or receive a signal), the IC chip (742) sends out characteristic sound signals as ID through the sound instrument (743). The characteristic sound signals for each person can be programmed if the IC chip (742) is equipped with programmable devices such as erasable programmable read only memory (EPROM) or programmable fuses. A security system will be able to check the ID upon receiving the characteristic sound signals. This key (741) needs a battery (744) to support its electrical operations. FIG. 8(c) shows an audio key (745) that has an air pump (746). When the air pump (746) is squeezed, air passes through a whistler (747) to send out characteristic sound signals. The whistler (741) has several openings (748). The characteristic sound of the whistler can be adjusted by covering some of the openings (748) with tape (749). It is certainly desirable that this whistler (747) is an ultrasound whistler so that other people cannot hear its characteristic sound. FIG. 8(d) shows an audio key that has multiple whistlers (751) that have a plurality of openings (752). The characteristic sound from each whistler can be adjusted by covering the openings (752) with tapes (753). The characteristic sound sent by this audio key is therefore programmable by covering different openings (752) on different whistlers (751). This audio key can send out sound if a user or an air pump blow air through it or if it is stimulated to reflect sound signals at its resonate frequencies. FIG. 8(e) shows an audio key (760) comprised a couple of vibration strings (761, 762). The characteristic sound emitted by those strings can be changed by adjusting the locations of markers (763, 765) under the strings (761, 762). A security system detects the sound emitted or reflected by those strings to verify the ID of the key carrier. FIG. 8(f0 shows an audio key (770) comprises a plurality of vibration strings (771-778). Vibration of the strings can be stopped by putting a stopper (779) under the string. For this example, 4 strings (772, 773, 779, 778) can not emit or reflect characteristic sound waves because they are blocked by stoppers (779), while the other 4 strings (771, 774, 775, 777) will emit or reflect characteristic sound waves. Therefore, a user can be identified by carrying the audio key (770) with different combinations of stopper locations.

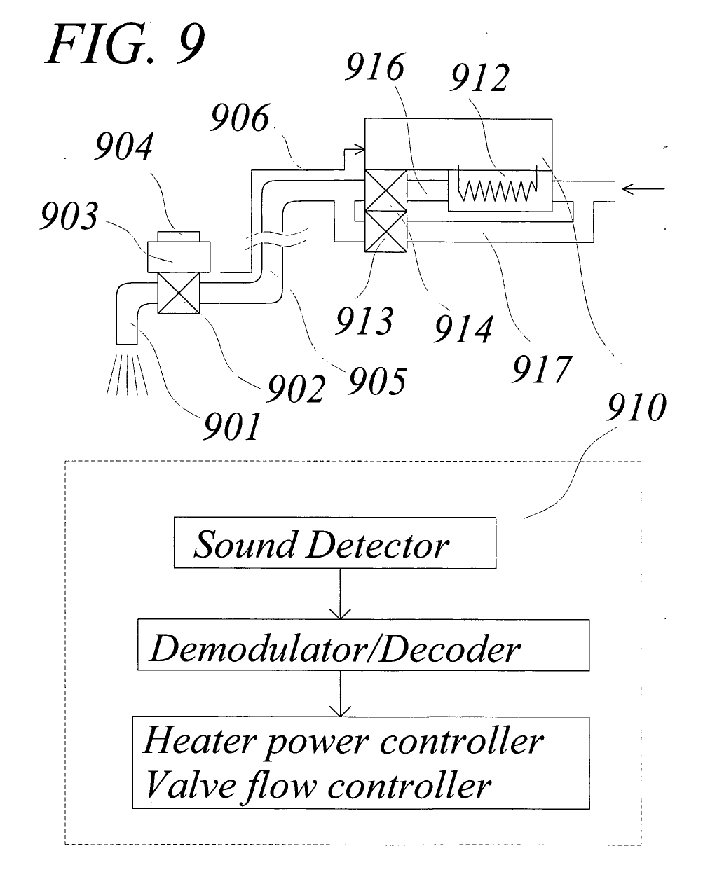

FIG. 9 shows an example in hot water supply system when water pipes are used to propagate sound signals of the present invention. A water faucet (901) is equipped with a faucet controller (903) that has a temperature dial (904) and controls a water valve (902). A user can rotate to temperature dial (904) to adjust the temperature of hot water. The faucet controller (903) sends out sound signals (906) indicating whether the water is too hot or too cold. This sound signal can be extremely simple. For example, the controller (903) can tap the pipe when the water is too cold, while making no sound when the water is too hot, or use a different pitch to tap the pipe when the water is too hot. Of cause, we also can make the sound signal very complex for advanced control functions. The sound signals (906) travel along the water pipe (905) and detected by a hot water controller (910). This hot water controller (910) controls a water heater (912) and water valves (914, 913). Incoming water goes through two pipes (916, 917) controlled by two valves (913, 914). The water in the hot water pipe (916) goes through the heater (912), and the water in the lower pipe (917) remains cold. The final temperature of the water is controlled by the heater (912) power as well as the mixture of hot/cold water by those two valves (913, 914). The hot water controller (910) comprises a sound detector that detects sound waves and sends the signal to signal processing units. The signal processing units interpret the meaning of the signal and controls heater power as well as opening of water valves to adjust water temperature. Using similar mechanism, we also can control the water flow.

The present invention uses modulated sound waves to support wireless operations. While specific embodiments of the invention have been illustrated and described herein, it is realized that other modifications and changes will occur to those skilled in the art. It is therefore to be understood that the appended claims are intended to cover all modifications and changes as fall within the true spirit and scope of the invention.

What is claimed is:

1. A wireless signal transfer device for sending signals from an input device to an electrical device using mechanical sound waves as signal carriers, said wireless signal transfer device comprises:
(a) an input device for receiving inputs,
(b) one or a plurality of instruments for sending out mechanical sound signals,
(c) control means for modifying the properties of the mechanical sound signals sent by said instrument(s) based on predefined relationships between said inputs and the properties of said mechanical sound signals,
(d) one or a plurality of sound detectors for converting said mechanical sound signals sent by said instrument(s) into electrical signals, and
(e) an electrical device for executing operations based on the electrical signals provided by said sound detector(s).

2. The control means in claim 1 modifies the amplitudes of the mechanical sound signals.

3. The control means in claim 1 modifies the phases of the mechanical sound signals.

4. The control means in claim 1 modifies the frequencies of the mechanical sound signals.

5. The control means in claim 1 modifies the tune of the mechanical sound signals.

6. The control means in claim 1 modifies the duty cycle of the mechanical sound signals.

7. The control means in claim 1 modifies the time interval between bursts of the mechanical sound signals.

8. The control means in claim 1 modifies the length of the mechanical sound signals.

9. The control means in claim 1 modifies more than one properties of the mechanical sound signals.

10. The control means in claim 1 modifies the properties of the mechanical sound signals using the same modulation methods used for radio frequency (RF) electromagnetic (EM) waves.

11. The wireless signal transfer device in claim 1 comprises a computer mouse.

12. The computer mouse in claim 11 comprises:
(a) a tracking ball,
(b) a instrument for sending out mechanical sound signals,
(c) an integrated circuit (IC) for modifying the properties of said mechanical sound signals in according to the mouse motions detected by said tracking ball.

13. The computer mouse in claim 11 comprises:
(a) a tracking ball,
(b) one or a plurality of sound instruments,
(c) control means that stimulates said sound instruments to send out characteristic mechanical sound signals based on the motion of said tracking ball.

14. The sound instrument(s) in claim 13 are vibration plate(s).

15. The computer mouse in claim 11 is an optical mouse.

16. The wireless signal transfer device in claim 1 comprises an adaptor that comprises
(a) a socket compatible with the socket of an existing wired connection,
(b) at least one sound detector for converting mechanical sound signals into electrical signals,
(c) electrical circuit components for translating said electrical signals in (b) into signals compatible with existing wired connections.

17. The socket in claim 16 is compatible with universal serial bus (USB) socket.

18. The socket in claim 16 is compatible with computer serial bus.

19. The socket in claim 16 is compatible with that of wired video game controller.

20. The socket in claim 16 is compatible with wired cellular phone headset connection.

21. The socket in claim 16 is compatible with wired telephone headset connection.

22. The socket in claim 16 is compatible with wired microphone connection.

23. The socket in claim 16 is compatible with wired earphone connection.

24. Means for improving signal quality for the signal transfer device in claim 1 comprises
(a) means to divide available bandwidth into multiple channels,
(b) means to evaluate signal quality in different channels,
(c) means to select proper channels for signal transfer.

25. The means to evaluate signal quality in claim 24 comprises
(a) means to sent out known data,
(b) means to compare transferred data with known data in order to measure the quality of a channel.

26. The means to evaluate signal quality in claim 24 comprise
(a) means to stop signal transfer for a quiet period of time,
(b) means to measure background noise during said quiet period in order to measure the quality of a channel.

27. The wireless signal transfer device in claim 1 comprises a video game controller.

28. The video game controller in claim 27 is connected to a game box through an adaptor in claim 18.

29. The video game controller in claim 27 is adapted to control game boxes of different brands.

30. The inputs to the input device in claim 1 are human voices.

31. The human voice in claim 30 is carried by modulated ultrasound signals for wireless transfer to communication devices.

32. The modulated ultrasound signals in claim 31 are digitized.

33. The wireless signal transfer device in claim 1 comprises a headset.

34. The headset in claim 33 communicates with a cellular phone through an adaptor of claim 20.

35. The wireless signal transfer device in claim 1 comprises a microphone.

36. The wireless signal transfer device in claim 1 comprises a cellular phone.

37. The wireless signal transfer device in claim 1 comprises a computer that comprises sound detector(s) for receiving mechanical sound signals form input devices.

38. The wireless signal transfer device in claim 1 comprises a computer that comprises instrument(s) for sending out mechanical sound signals to control other devices.

39. The wireless signal transfer device in claim 1 comprises a telephone answering machine that provides the options to send out mechanical sound signals for controlling other devices.

40. The wireless signal transfer device in claim 1 comprises a switch that response to mechanical sound signals.

41. The wireless signal transfer device in claim 1 comprises a converter that converts the mechanical sound signals into other types of wireless control signals.

42. The wireless control signals in claim 41 are infrared (IR) remote control signals.

43. The input device in claim 1 is a motion detector.

44. The instrument in claim 1 is an audio key for sending out characteristic mechanical sound signals for identification (ID)).

45. The audio key in claim 44 comprises electrical circuits that control the sound ID signals sent by sound instrument.

46. The electrical circuits in claim 45 comprise programmable devices for programming the ID signals.

47. The audio key in claim 44 comprises an air pump for stimulating sound signals.

48. The audio key in claim 44 comprises at least one whistler for sending out ID sound signals.

49. The whistler in claim 48 comprises means to adjust it ID sound signals.

50. The audio key in claim 44 comprises at least on string for sending out ID sound signals.

51. The string in claim 50 comprises means to adjust its ID sound signals.

52. The mechanical sound signals in claim 1 are ultrasound signals.
